(19) United States
(12) Patent Application Publication
(10) Pub. No.: US 2011/0320346 A1
(43) Pub. Date: Dec. 29, 2011

(54) COMPUTERIZED SYSTEM AND METHOD FOR PROVIDING A MARKET STABILIZED INVESTMENT PRODUCT

(76) Inventors: Mendy Reichman, New York, NY (US); Dominique Baede, New York, NY (US)

(21) Appl. No.: 13/167,224

(22) Filed: Jun. 23, 2011

Related U.S. Application Data
(60) Provisional application No. 61/357,778, filed on Jun. 23, 2010.

(51) Int. Cl. G06Q 40/00

(52) U.S. Cl. 705/39

(57) ABSTRACT

The present invention provides a method and system for providing a market stabilized financial vehicle. The method and system includes calculating a growth cap rate and loss protection rate associated with a market stabilized financial vehicle, wherein the growth cap rate and loss protection rate are linked to an indexed market. The method and system further comprises transferring a plurality of funds to a segment account associated with the market stabilized financial vehicle and associating, on a point-to-point basis, a percentage change in the index based security with a maturity value of the financial vehicle, wherein the associating a percentage change occurs between the growth cap rate and loss protection rate. The method and system further comprises applying the index linked percentage change and determining a maturity value of the segment account.

### CROSS REFERENCE TO RELATED APPLICATIONS

This application claims the benefit of U.S. Provisional Application Ser. No. 61/357,778, filed Jun. 23, 2010, which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

Embodiments of the invention described herein generally relate to providing a market stabilized investment option (referred to, interchangeably, as a “market stabilized investment financial product”). More specifically, embodiments of the present invention are directed towards systems and methods for generating a market stabilized investment option tied to an investment index and providing the option to a plurality of account holders.

### BACKGROUND OF THE INVENTION

Certain financial and insurance products provide for the payment by one party at one time and the benefits of payouts at a later point in time. Classic examples are life insurance policies or annuities. Many of these products include one or more guaranteed payouts at future dates, financed by investing premiums in various investment assets such as equities, bonds, and cash. Proper management of the financial assets underlying the investments is important to insure that funds are available for the guaranteed payments.

A traditional annuity is generally a contract between one or more individual investors, annuitant(s), and an insurance company, under which the annuitant makes a lump-sum payment or series of payments. In return, the insurer agrees to make periodic payments to the annuitant or other beneficiary beginning immediately or at some future date. There are generally two types of annuities—fixed and variable. In a fixed annuity, the insurance company guarantees that the annuitant will earn a minimum rate of interest during the time that the annuitant's account is growing. The insurance company also guarantees that the periodic payments will be a guaranteed amount per dollar in the annuitant's account. These periodic payments may last for a definite period, such as 20 years, or an indefinite period, such as an annuitant's lifetime or the lifetime of annuitant and the annuitant's spouse.

Variable annuities allow money to be invested in insurance company “separate accounts” (which are sometimes referred to as “subaccounts” and in any case are functionally similar to mutual funds) in a tax-deferred manner. Their primary use is to allow an investor to engage in tax-deferred investing for retirement in amounts greater than permitted by individual retirement or 401(k) plans. In addition, many variable annuity contracts offer a guaranteed minimum rate of return (either for a future withdrawal and/or in the case of the owner's death), even if the underlying separate account investments perform poorly. This can be attractive to people uncomfortable investing in the equity markets that do not guarantee a rate of return.

With a guaranteed rate of return, both fixed and variable annuities are generally limited in their potential for growth. To maximize growth, some annuities invest funds directly in the stock market through the purchase of mutual funds. The inherent risk with this type of direct investment in the market threatens the stability of fixed and variable annuities without necessarily leading to additional gains. An alternative is the equity indexed annuity which invests in a derivative instrument, the equity index. Typical equity indexed annuities still offer a minimum rate of return while allowing the annuitant to participate in the market by crediting the annuity based on a formula that is linked to the performance of the equity index. Unfortunately, the interest rate realized by the current set of equity indexed annuities does not match the performance of the equity index the annuity invests in. Instead, the rate of return is only a percentage of the performance and will depend on a number of variables including, inter alia, the participation rate, choice of index, administrative costs and management fees.

As such, there is a need to provide investors a balanced financial vehicle to permit the realization of stronger returns that safely protects against loss to the principal. There is also a need to provide a more transparent system and method for the typical financial vehicles that utilize derivatives through a more precise correlation between the performance of the derivative instrument and the performance of the financial vehicle.

### SUMMARY OF THE INVENTION

The present invention is directed towards systems and methods for providing a market stabilized financial product to a client. In one embodiment, a method electronically links a growth cap rate and loss protection rate associated with a market stabilized financial product to a market index. In one embodiment, the growth cap rate is selected from a plurality of rates. In another embodiment, the loss protection rate is selected from a plurality of rates. In another embodiment, the growth cap rate and loss protection rates are selected dynamically.

The method further electronically transfers a plurality of client funds to a segment account associated with the market stabilized financial product. In one embodiment, transferring a plurality of funds to a segment account associated with the market stabilized option occurs at a predetermined segment start date wherein the segment start date occurs on a predetermined periodic basis.

The method further electronically determines a percentage change in the market index and associating, on a point-to-point basis, the percentage change with a maturity value of the market stabilized financial product, wherein the percentage change falls between the growth cap rate and loss protection rate. The method further electronically applies the index linked percentage change and determines a maturity value of the segment account. In one embodiment, associating a percentage change in the index based security with a maturity value of the financial vehicle comprises placing a plurality of call and put options on the security underlying the indexed market. In another embodiment, applying the index linked percentage change and determining a maturity value of the segment account occurs at a predetermined segment maturity date wherein the segment maturity date is a year after the segment start date. Finally, the method electronically transfers the maturity value of the segment account to a second account.

The present invention is further directed towards a method for preserving charges associated with a market stabilized financial product. The method comprises establishing a charge reserve account for holding at least a partial amount of the market stabilized financial product account value and calculating a balance after deduction of monthly charges and crediting of current interest. The method then determines an amount of the calculated balance to transfer into the charge reserve account and transfers the determined amount to the charge reserve account at a predefined time. In one embodiment, transferring the determined amount to the charge reserve account at a predefined time comprises transferring the determined amount to an unloaned general interest account.

The present invention is further directed towards a system for providing a market stabilized financial product. The system comprises a growth cap calculator operative to calculate a growth cap rate and loss protection rate associated with a market stabilized financial product, wherein the growth cap rate and loss protection rate are linked to an market index. In one embodiment, the growth cap rate is selected from a plurality of rates. In an alternative embodiment, the loss protection rate is selected from a plurality of rates. In another alternative embodiment, the growth cap rate and loss protection rates are selected dynamically.

The system further comprises a processor operative to transfer a plurality of funds to a segment account associated with the market stabilized financial products. In one embodiment, transferring a plurality of funds to a segment account associated with the market stabilized option occurs at a predetermined segment start date, wherein the segment start date occurs on a predetermined periodic basis.

The processor may further be operative to associate, on a point-to-point basis, the percentage change with a maturity value of the market stabilized financial product, wherein the percentage change falls between the growth cap rate and loss protection rate. In one embodiment, associating a percentage change in the index based security with a maturity value of the financial vehicle comprises placing a plurality of call and put options on the security underlying the indexed market.

The processor may further apply the index linked percentage change and determining a maturity value of the segment account. In one embodiment, applying the index linked percentage change and determining a maturity value of the segment account occurs at a predetermined segment maturity date, wherein the segment maturity date is a year after the segment start date. The processer further transfers the maturity value of the segment account to a second account.

The present invention is further directed towards a system for preserving charges associated with a market stabilized financial product. The system comprises a charge reserve account for holding at least a partial amount of the market stabilized financial product account value and a processing device. The processing device is operative to calculate a balance after deduction of monthly charges and crediting of current interest; determine an amount of the calculated balanced to transfer into the charge reserve account; and transfer the determined amount to the charge reserve account at a predefined time. In one embodiment, transferring the determined amount to the charge reserve account at a predefined time comprises transferring the determined amount to an unloaned general interest account.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a graph diagram illustrating the mechanics of a market stabilized investment option according to one embodiment of the present invention.

FIG. 2 presents a system diagram illustrating a system for providing a market stabilized option according to one embodiment of the present invention.

FIG. 3 presents a flow diagram illustrating a method for calculating a growth cap and loss protection rate according to one embodiment of the present invention;

FIG. 4 presents a flow diagram illustrating a method for adjusting an underlying option package using index-linked crediting techniques according to one embodiment of the present invention; and

FIG. 5 presents a flow diagram illustrating a method for providing a charge reserve account according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

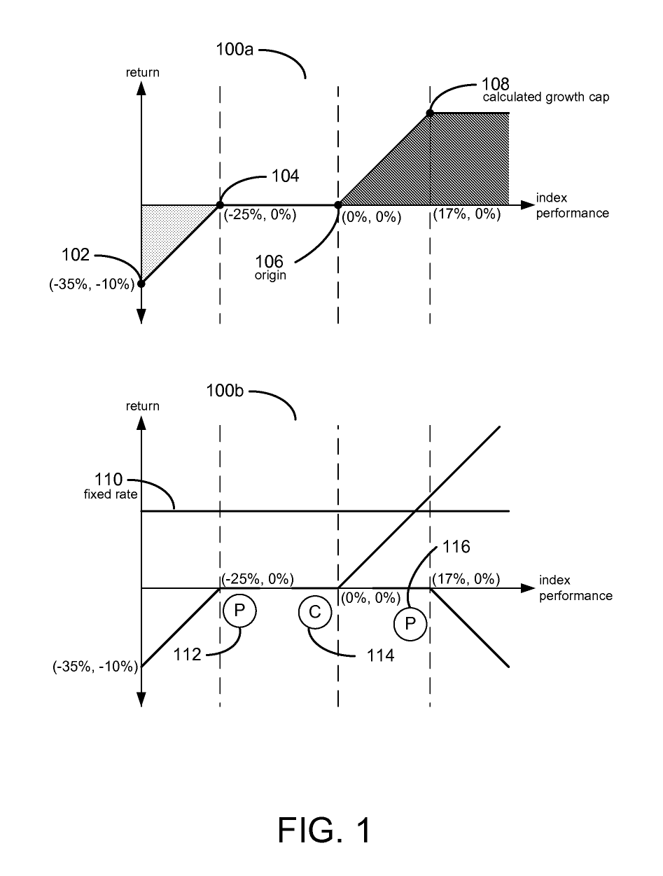

FIG. 1 presents a graph diagram illustrating the mechanics of a market stabilized investment option (“MSO”) or product according to one embodiment of the present invention. As the embodiment of FIG. 1 illustrates, a first graph 100a illustrates an exemplary embodiment of a segment maturity value curve. In the illustrated embodiment, graph 100a depicts the return of a financial product (y-axis) as a function of the performance of the underlying instrument (x-axis), wherein point 106 represents the origin of the graph 100a. As illustrated, an index-based security's (e.g., the S&P 500) rate of return may increase proportionally to the index value until point 108. Point 108 represents a calculated growth cap. In one embodiment, after the interest crediting reaches point 108, the interest crediting rate may remain constant for subsequent increases in the index value.

Conversely, if the index value loses value, the interest crediting may remain constant. As illustrated in FIG. 1, an index value may decrease from point 106 to point 104. For example, an index value may decrease from 0% return (106) to a −25% return (104). In the illustrated embodiment, the interest crediting may remain constant (0%) until the index value reaches the minimum growth cap rate 104. If the index value decreases beyond the minimum growth cap rate 104, the interest crediting may begin to decrease. For example, at point 102, the index value may be −35%, wherein the interest crediting may be decreased based on the difference between 102 and 104, i.e., −10%.

Graph 100b illustrates a mechanism for replicating fluctuations of an indexed based market as applied to an investment account provided by the market stabilized investment option. An annuity provider may purchase an underlying financial instrument, such as a bond, at a fixed rate indicated by axis 110. For example, the annuity provider may purchase a bond having a value of $97.75 (a value of $100, less fees). Graph 100b simulates the market illustrated in graph 100a as discussed further herein.

Upon detecting that the indexed market experiences a downturn, beyond the loss protection rate 104, the annuity provider may place an out-of-money put 112 to replicate the downside greater than the loss protection rate 104. Alternatively, if the indexed market increases, an at-the-money call 114 may be purchased and an out-of-money call 116 may be sold to replicate the market increase. In alternative embodiments, if the indexed market increases beyond the growth cap, the annuity provider may receive those funds above the pre-determined growth cap.

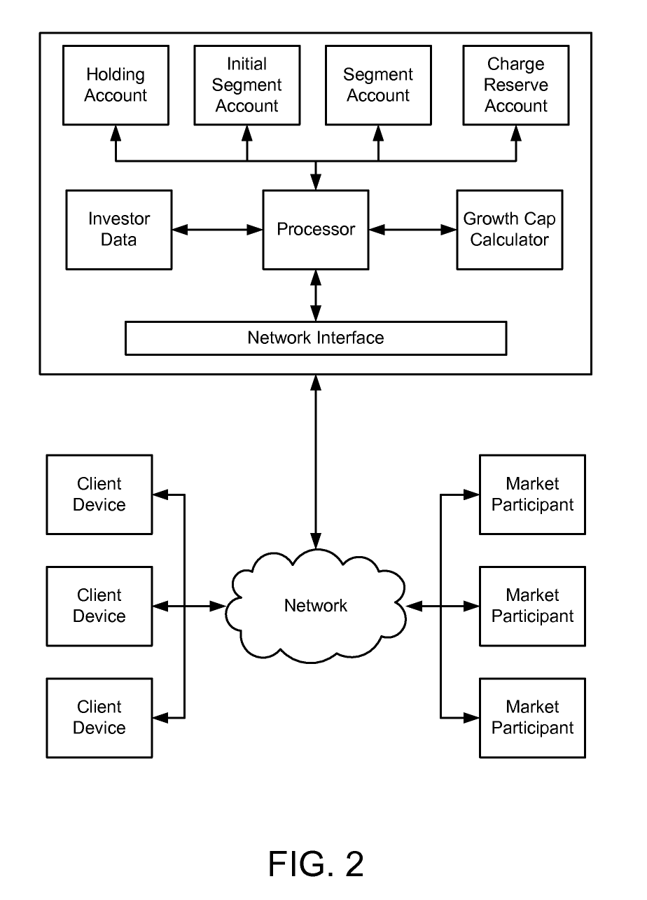

FIG. 2 presents a system diagram illustrating a system for providing a market stabilized option according to one embodiment of the present invention. As the embodiment of FIG. 2 illustrates, a plurality of client devices 202a, 202b, 202c and market participants 204a, 204b, 204c are connected to an annuity provider 206 via a network 208. Annuity provider 206 comprises a network interface 210, processor 212, growth cap calculator 214, investor data store 216, and a plurality of accounts 218-224 including a holding account 218, an initial segment account 220, a segment account 222, and a charge reserve account 224.

As illustrated, a client device 202a, 202b, 202c may comprise a general purpose computing device such as a personal computer or portable computing device, the computer or device having a processor, memory, and input/output devices. In one embodiment, a participant in an annuity provided by annuity provider 206 may operate a client device 202a, 202b, 202c. In this embodiment, a participant may be able to, inter alia, inspect, modify, or remove funds invested in annuity provider 206. In an alternative embodiment, an employee of annuity provider 206 or other authorized user may operate client device 202a, 202b, 202c. In this embodiment, an employee or authorized user may be able to, inter alia, transfer funds, modify system configurations, or perform various other administrative tasks.

Client devices 202a, 202b, 202c communicate with the annuity provider 206 through a network interface 210 provided by annuity provider 206. Such an interface may comprise various hardware and software components known in the art of computer networking. Processor 212 may be operative to handle incoming requests from client devices 202a, 202b, 202c. Although illustrated as a single device, processor 212 may comprise a plurality of hardware and software components communicating with each other to perform various computational processes.

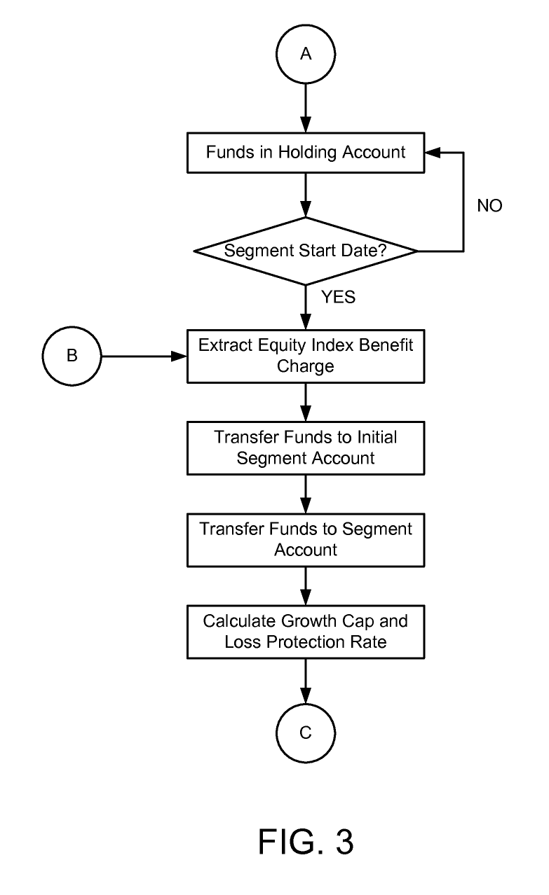

Processor 212 is further coupled to a growth cap calculator 214. In the illustrated embodiment, processor 212 may transmit a request for a growth cap and/or loss protection cap to growth cap calculator 214. As previously discussed, a growth cap or loss protection cap may comprise a ceiling and floor associated with an indexed fund such as the S&P 500. Particular calculations performed by the growth cap calculator 214 are further discussed with respect to FIG. 3 and are not repeated here for clarity's sake. In one embodiment, processor 212 transmits a request for a growth cap and/or loss protection cap at the beginning of a predefined segment term. In alternative embodiments, processor 212 may transmit a request for a growth cap and/or loss protection cap on a rolling basis through a segment term.

Processor 212 is additionally coupled to an investor data store 216. In the illustrated embodiment, investor data store 216 comprise a plurality of databases containing investor data, that is, data related to customers of the annuity provider 206. For example, investor data store 216 may comprise records of customer account data including linking data associating a particular investor to a plurality of accounts, including those held in accounts 218-224. Processor 212 may utilize investor data store 216 to initiate and complete transactions between the plurality of accounts 218-224, as well as initiate transactions with market participants 204a, 204b, 204c.

In addition to the foregoing, processor 212 may be operative to process a request for opting into a market stabilized option account. In response to such a request, processor 212 may transfer a plurality of investor funds into a holding account 218. In the illustrated embodiment, holding account 218 represents a temporary account utilized to pool investor funds until processor 212 determines that a segment start date has occurred. In one embodiment, the holding account 218 may comprise a pre-existing account type (not shown) such as a money market investment account used for other annuities provided by annuity provider 206.

When a segment start date occurs, processor 212 may be operative to perform a plurality of fee calculations to extract pre-defined fees associated with the MSO. For example, processor 212 may extract a equity index benefit charge, predefined by the annuity provider 206. After extracting any defined fees, processor 212 transfers the net funds into the initial segment account 220. Processor 212 then transfers the funds in the initial segment account 220 for a given segment (less any loans, guideline premium force-outs, monthly deductions allocated to the segment due to insufficient funds elsewhere, and corresponding Market Value Adjustments, prior to the index linked crediting on the Segment Maturity Date) to the segment account 224. Processor 212 utilizes the segment account 224 to determine policy account values, death benefits, and the net amount at risk for monthly COI calculations.

As discussed with respect to FIG. 1, while funds are in the segment account 224, processor 212 may dynamically determine an index-linked credit rating associated with the segment account 224. In the illustrated embodiment, processor 212 is operative to initially purchase a financial instrument, such as a bond, using the funds in the segment account. During the segment term, processor 212 analyzes the indexed account through market participants 204a, 204b, 204c and places out-of-money put options to replicate a downturn in the indexed fund. Additionally, processor 212 may place at-the-money calls and out-of-money calls to replicated an upturn in the indexed fund.

Such processing occurs throughout the segment term until segment maturity. When the segment term ends, annuity provider 206 may provide the investor a choice in transferring funds between accounts. In one embodiment, the annuity provider 206 may automatically re-invest the funds in the segment account 224 in the manner described above.

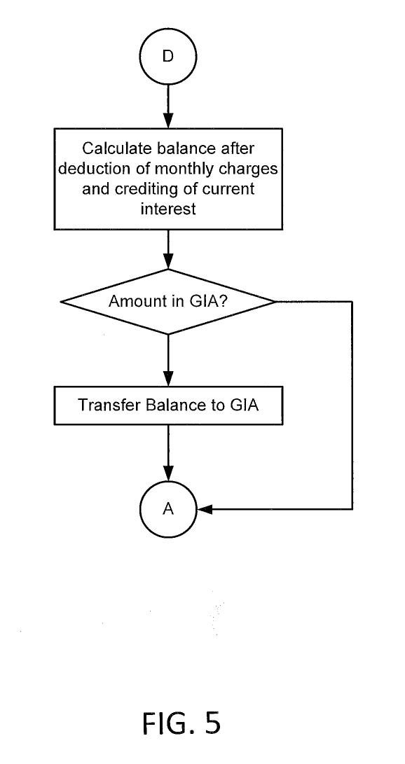

Processor 212 is further operative to transfer funds to a charge reserve account 226. In the illustrated embodiment, upon reaching the segment start date, processor 212 may automatically calculate the values of funds to be transferred to the charge reserve account 212. Such operation ensures the investor retains funds needed for various charges during the segment term. In one embodiment, the charge reserve account 212 may comprise a portion of an unloaned general interest account. Functionality of the charge reserve account 212 is discussed more fully with respect to FIG. 5.

FIG. 3 presents a flow diagram illustrating a method for calculating a growth cap and loss protection rate according to one embodiment of the present invention. As the embodiment of FIG. 2 illustrates, a method 300 places funds in a holding account, step 302. In one embodiment, placing funds in a holding account comprises placing a portion of a regular Money Market Investment Option which holds amounts allocated to the MSO until transfer to a new segment on the segment start date.

The method 300 then determines if a segment start date occurs, step 304. If the date has not occurred, the method 300 continues to maintain the funds in the holding account. In one embodiment, a segment start date is the date on which a segment is created. The method 300 may create new segments on the 15th day of each calendar month (or soonest business day thereafter). In alternative embodiments, the method may create segments less frequently in the future. As illustrated, amounts allocated to the MSO on or before the last business day prior to such date will remain in a Holding Account until transfer on the Segment Start Date.

If a segment start date occurs, the method 300 extracts the equity index benefit charge, step 306. For example, the method 300 may extract a benefit charge of 75 BPS for participation in the MSO. The method 300 then transfers the funds to an initial segment account, step 308. In one embodiment, the initial segment account may act as a staging ground prior to a final transfer to a segment account. Funds in the initial segment account may comprise the final segment account value minus any loans, any guideline premium force-outs, and any monthly deductions allocated to the segment due to insufficient funds elsewhere, and corresponding Market Value Adjustments, prior to the index linked crediting on the Segment Maturity Date. In one embodiment, a policy holder may have a plurality of options to select from. For example, multiple MSOs may be provided with varying growth rates and loss protection rates (e.g., varying degrees of risk).

The method 300 then calculates a growth cap and loss protection rates, step 310. As discussed with respect to FIG. 1, growth cap and loss protection rates may comprise a maximum and minimum guaranteed investment. A current growth cap and loss protection rate may be declared on the Segment Start Date of each one-year segment and may remain in effect for the full one-year term. If at the time the current growth cap rate is declared, the interest rate currently being credited to the unloaned GIA is higher than such growth cap rate, the MSO rider will provide for an automatic transfer from the holding (where amounts allocated to the MSO are held pending transfer on the segment start date) to the unloaned GIA.

In the illustrated embodiment, the method 300 may calculate an available option budget having the form:

$$Option Budget = Initial Segment Account \times \frac{Fixed Yield}{1 + Fixed Yield} + Variable Index Benefit Change \qquad Equation 1$$

The method 300 may then determine an optimal cap by finding a cap value wherein the Option Budget in Equation 1 is equal to the cost of the underlying option package, the cost of the underlying option package determined through the following equation:

$$Cost of Underlying Option Package = C ( S , S , t , r , q , {σ}_{100} ) - P ( S , 0.75 \times S , t , r , q , {σ}_{75} ) + C ( S , S \times ( 1 + cap ) , t , r , q , {σ}_{100 ( 1 + cap )} ) \qquad Equation 2$$

Functions C and P are defined as follows:

C(S,K,t,r,q,σ)=Se^{-q(T-t)}N(d₁)−Ke^{-r(T-t)}N(d₂)

P(S,K,t,r,q,σ)=Ke^{-r(T-t)}N(−d₂)−Se^{-q(T-t)}N(−d₁)

where

$${d}_{1} = \frac{ln ( \frac{S}{K} ) + ( r - q + \frac{{σ}^{2}}{2} ) ( T - t )}{σ \sqrt{( T - t )}} \\ {d}_{2} = {d}_{1} - σ \sqrt{( T - t )} \qquad Equation 3$$

Where, N( ) is the standard normal cumulative distribution function; (T−t) is time to maturity; S is the spot price of the underlying asset; K is the strike price; r is the risk free rate (annual rate, expressed in terms of continuous compounding); σ is the volatility in the log-returns of the underlying asset; q is the dividend yield of the underlying asset; and cap is the optimal cap value to be determined. After the method 300 solves for cap, the method 300 sets the cap value and transfers the funds to the segment account, step 312.

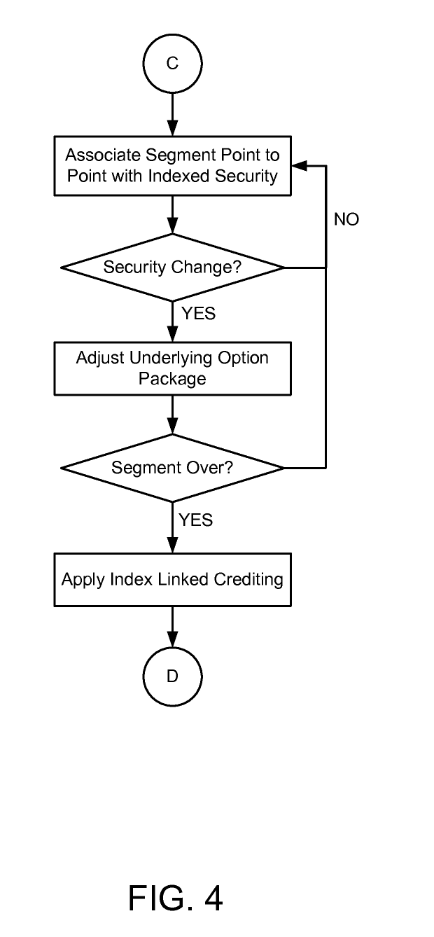

FIG. 4 presents a flow diagram illustrating a method for adjusting an underlying option package using index-linked crediting techniques according to one embodiment of the present invention. As the embodiment of FIG. 4 illustrates, a method 400 associates a segment with an indexed security on a point to point basis, step 402. In one embodiment, the method 400 associates the segment on a point to point basis with the S&P 500. For example, if the S&P 500 Index has increased by 20% over the Segment Term, and we have declared a 17% Growth Cap Rate for that segment, then 17% will be the Index Linked Crediting Rate used to calculate the return for the segment and the Segment Maturity Value.

The method 400 monitors the linked security to determine if a change in the security has occurred, step 404. If a change is detected, the method 400 adjusts the underlying option package, step 406. For example, the Index Linked Crediting Rate will be 0% if the performance of the S&P 500 Index over the Segment Term is between zero and negative 25%. If the Index declines by more than 25% during that time, any percentage decline in excess of 25% will reduce the Segment Maturity Value. For example, if the S&P 500 Index declines by 27% from the Segment Start Date to the Segment Maturity Date, the Index Linked Crediting Rate will be −2%. In other words, the insurer will absorb any loss up to and including the first 25%, with no reduction in the policy owner's Segment Maturity Value. This protection against declines of up to 25% annually will be guaranteed for each segment held to Segment Maturity.

For purposes of adjusting the underlying option package during the Segment Term, a Market Value Adjustment is equal to (1) the Put Option Unit Price multiplied by the current Segment Account, minus (2) the Equity Index Benefit Charge multiplied by the current Segment Account, divided by one minus the Equity Index Benefit Charge. The second item is a refund of the Equity Index Benefit Charge upon surrender.

For purposes of determining the adjustment to the Segment Account when any portion of a loan or guideline premium force-out is redeemed from a segment, or when any portion of a monthly deduction is redeemed from a segment due to insufficient funds elsewhere, the formula is more complex and is therefore provided in the actuarial basis memorandum.

Steps 402, 404, and 406 continue for the length of the segment, step 408. In one embodiment, segments under the MSO will be approximately one year in duration (depending upon business days) and are based on the calendar year. Since funds will be allocated to segments with fixed monthly start dates, after the rider has been available for one year a single policy could conceivably have amounts allocated to a maximum of 12 separate segments at any point in time.

If the method 400 determines a segment is over, the method 400 applies the index linked crediting, step 410. For example, segments will mature on the 15th day of the calendar month (or soonest business day thereafter) that is approximately one year from the Segment Start Date. The Segment Maturity Value can be transferred from the MSO to the unloaned GIA or the variable investment options at Segment Maturity at the policy owner's direction. In one embodiment, if the policy owner does not instruct otherwise, the Segment Maturity Value, less an Equity Index Benefit Charge (step 306) corresponding to a new Segment Term, and less any amount transferred to the GIA to cover the next 12 monthly deductions (FIG. 5), will be rolled over automatically into a new segment on the new Segment Start Date (FIG. 3).

FIG. 5 presents a flow diagram illustrating a method for providing a charge reserve account according to one embodiment of the present invention. As the embodiment of FIG. 5 illustrates, a method 500 calculates a balance after the deduction of monthly charges and crediting of current interest, step 502. In one embodiment, if the policy owner wishes to utilize the MSO, the MSO rider will require that a minimum amount of policy account value be available to be transferred into the unloaned GIA (if not already present in the unloaned GIA), and that the balance after deduction of monthly charges and crediting of current interest remain there during the segment term. This charge reserve account will be determined as an amount sufficient to cover all monthly deductions for twelve months, assuming at the time such calculation is made that no interest or investment performance is credited to or charged against the policy account value and that no policy changes or additional premium payments are made.

In the illustrating embodiment, the charge reserve account will be determined on each applicable segment start date, and any necessary transfers to supplement the amount already present in the unloaned GIA in order to meet this requirement will take effect on that date, step 504. Any such transfer from the investment funds in the segment account including the Holding Account may be made in accordance with the policy owner's directions. The policy owner's transfer instructions may be requested as part of the process for initially selecting the MSO or renewing it upon segment maturity. Although illustrated as first occurring after the segment maturity date, the operations performed by method 500 may occur at any segment start date.

If no directions are received, or if the requested allocation is not possible due to insufficient funds, the required amount will be transferred pro-rata from the investment funds of the segment account, excluding the holding account. However, if the values in the investment funds of the segment account, excluding the holding account, are insufficient, any remaining portion of the required amount will be transferred from the holding account, step 506.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A computerized method utilizing a processing device for providing a market stabilized financial product to a client, the method comprising:
electronically linking a growth cap rate and loss protection rate associated with a market stabilized financial product to a market index;
electronically transferring a plurality of client funds to a segment account associated with the market stabilized financial product;
electronically determining a percentage change in the market index and associating, on a point-to-point basis, the percentage change with a maturity value of the market stabilized financial product, wherein the percentage change falls between the growth cap rate and loss protection rate;
electronically applying the index linked percentage change and determining a maturity value of the segment account; and
electronically transferring the maturity value of the segment account to a second account.

2. The method of claim 1 wherein the growth cap rate is selected from a plurality of rates.

3. The method of claim 1 wherein the loss protection rate is selected from a plurality of rates.

4. The method of claim 1 wherein the growth cap rate and loss protection rates are selected dynamically.

5. The method of claim 1 wherein associating the percentage change with a maturity value of the market stabilized financial product comprises placing a plurality of call and put options on the security underlying the market index.

6. The method of claim 1 wherein transferring a plurality of funds to a segment account associated with the market stabilized financial vehicle occurs at a predetermined segment start date.

7. The method of claim 6 wherein the segment start date occurs on a predetermined periodic basis.

8. The method of claim 6 wherein applying the index linked percentage change and determining a maturity value of the segment account occurs at a predetermined segment maturity date.

9. The method of claim 6 wherein the segment maturity date is a year after the segment start date.

10. A computerized method for preserving charges associated with a market stabilized financial product comprising:
establishing a charge reserve account for holding at least a partial amount of the market stabilized financial product account value;
calculating a balance after deduction of monthly charges and crediting of current interest;
determining an amount of the calculated balance to transfer into the charge reserve account; and
transferring the determined amount to the charge reserve account at a predefined time.

11. The method of claim 10 wherein transferring the determined amount to the charge reserve account at a predefined time comprises transferring the determined amount to an unloaned general interest account.

12. A system for providing a market stabilized financial product, the system comprising:
a growth cap calculator operative to calculate a growth cap rate and loss protection rate associated with a market stabilized financial product, wherein the growth cap rate and loss protection rate are linked to market index;
a processing device operative to:
transfer a plurality of funds to a segment account associated with the market stabilized financial product;
associating, on a point-to-point basis, the percentage change with a maturity value of the market stabilized financial product, wherein the percentage change falls between the growth cap rate and loss protection rate; and
applying the index linked percentage change and determining a maturity value of the segment account; and
transferring the maturity value of the segment account to a second account

13. The system of claim 12 wherein the growth cap rate is selected from a plurality of rates.

14. The system of claim 12 wherein the loss protection rate is selected from a plurality of rates.

15. The system of claim 12 wherein the growth cap rate and loss protection rates are selected dynamically.

16. The system of claim 12 wherein associating the percentage change with a maturity value of the market stabilized financial product comprises placing a plurality of call and put options on the security underlying the market index.

17. The system of claim 12 wherein transferring a plurality of funds to a segment account associated with the market stabilized financial vehicle occurs at a predetermined segment start date.

18. The system of claim 17 wherein the segment start date occurs on a predetermined periodic basis.

19. The system of claim 17 wherein applying the index linked percentage change and determining a maturity value of the segment account occurs at a predetermined segment maturity date.

20. The system of claim 17 wherein the segment maturity date is a year after the segment start date.

21. A system for preserving charges associated with a market stabilized financial product, the system comprising:
a charge reserve account for holding at least a partial amount of the market stabilized financial product account value;
a processing device for
calculating a balance after deduction of monthly charges and crediting of current interest;
determining an amount of the calculated balanced to transfer into the charge reserve account; and
transferring the determined amount to the charge reserve account at a predefined time.

22. The system of claim 21 wherein transferring the determined amount to the charge reserve account at a predefined time comprises transferring the determined amount to an unloaned general interest account.
